(19) United States
(12) Patent Application Publication
(10) Pub. No.: US 2016/0117015 A1
(43) Pub. Date: Apr. 28, 2016

(54) MICROELECTROMECHANICAL VIBRATION SENSOR

(71) Applicant: STMICROELECTRONICS S.R.L., Agrate Brianza (IT)

(72) Inventors: Marco Veneri, Milan (IT); Stefano Bosco, Gessate (IT); Alessandro Morcelli, Montello (IT)

(21) Appl. No.: 14/839,604

(22) Filed: Aug. 28, 2015

(30) Foreign Application Priority Data
Oct. 28, 2014 (IT) TO2014A000878

(51) Int. Cl. G06F 3/044; G06F 3/043; G06F 3/041

(52) U.S. Cl. CPC G06F 3/044; G06F 3/0412; G06F 3/0433

(57) ABSTRACT

A microelectromechanical vibration sensor includes: a first chamber; a second chamber; a semiconductor membrane between the first chamber and the second chamber; a reference electrode, capacitively coupled to the membrane; and a package structure, which encapsulates and insulates acoustically from the outside world the first chamber, the second chamber, and the membrane.

### BACKGROUND

1. Technical Field

The present invention relates to a microelectromechanical vibration sensor.

2. Description of the Related Art

As is known, one way to detect vibrations in a body is to use a microelectromechanical accelerometer rigidly connected to the body itself A microelectromechanical accelerometer presents the advantage of having small dimensions, together with a very high sensitivity and very low consumption levels. It is thus easy to incorporate a microelectromechanical accelerometer even in small-sized portable devices and thus extend significantly the range of available functions. In particular, the signals supplied by the sensors may be processed for extracting information on the nature of the events detected. For example, some portable communication and/or processing devices (smartphones, tablets, portable computers) are provided with touch screens. Touch-detection systems normally enable only locating the touch events and, possibly, tracking the movement on the screen. Use of an accelerometer may enable discrimination of how a touch event has been generated (by the fingertip, a nail, a knuckle, a hard tip, etc.). Further, the majority of current portable communication and/or processing devices are already provided with accelerometers for functions different from detection of vibrations (for example, microelectromechanical accelerometers are commonly used for determining the orientation of the device or for recognizing free-fall conditions).

Microelectromechanical accelerometers generally comprise a mobile mass elastically constrained to a supporting structure. The mobile mass is further capacitively coupled to the supporting structure by a system of mobile and fixed electrodes.

However, the structure of the microelectromechanical accelerometers commonly used is complex, and production thereof is costly. In addition, the bandwidth of microelectromechanical accelerometers sometimes is not sufficient to enable classification of the events (such as touch events on a screen).

### BRIEF SUMMARY

One or more embodiments of the present invention are directed to a microelectromechanical vibration sensor and a method of forming same.

One embodiment is directed to a microelectromechanical vibration sensor comprising a first chamber, a second chamber, and a semiconductor membrane between the first chamber and the second chamber. The sensor further includes a reference electrode capacitively coupled to the membrane. The sensor further includes a package structure that encapsulates and acoustically isolates the first chamber, the second chamber and the membrane from environments outside of the package structure.

### BRIEF DESCRIPTION OF THE SEVERAL VIEWS OF THE DRAWINGS

For a better understanding of the invention, an embodiment thereof will now be described, purely by way of non-limiting example and with reference to the attached drawings, wherein:

FIG. 1 is a partially sectioned side view of an electronic device incorporating a microelectromechanical vibration sensor according to an embodiment of the present invention;

FIG. 2 is a cross-section through the microelectromechanical vibration sensor of FIG. 1;

FIG. 3 is a cross-section at an enlarged scale through a component of the microelectromechanical vibration sensor of FIG. 1;

FIG. 4 is an exploded perspective view of the microelectromechanical vibration sensor of FIG. 1;

FIG. 5 is a simplified block diagram of the microelectromechanical vibration sensor of FIG. 1;

FIG. 6 is a simplified block diagram of the electronic device of FIG. 1;

FIG. 7 is a cross-section through a component of a microelectromechanical vibration sensor according to a different embodiment of the present invention;

FIG. 8 is a cross-section through a microelectromechanical sensor according to a further embodiment of the present invention; and

FIG. 9 is a cross-section through a microelectromechanical sensor according to a further different embodiment of the present invention.

### DETAILED DESCRIPTION

The ensuing treatment will make reference, for convenience, to a specific example of application, i.e., use of a vibration sensor in a portable communication/processing device provided with touch-screen, for detecting and classifying touch events. It is understood, however, that the example is non-limiting and what is described extends to any possible use of a vibration sensor.

By “touch event” is meant here and in what follows a contact of a body with the touch-screen, said contact producing vibrations that may be detected by the vibration sensor described. The body may, for example, be a fingertip, a nail, a knuckle, the tip of a stylus or of a pen, whether dielectric or conductive.

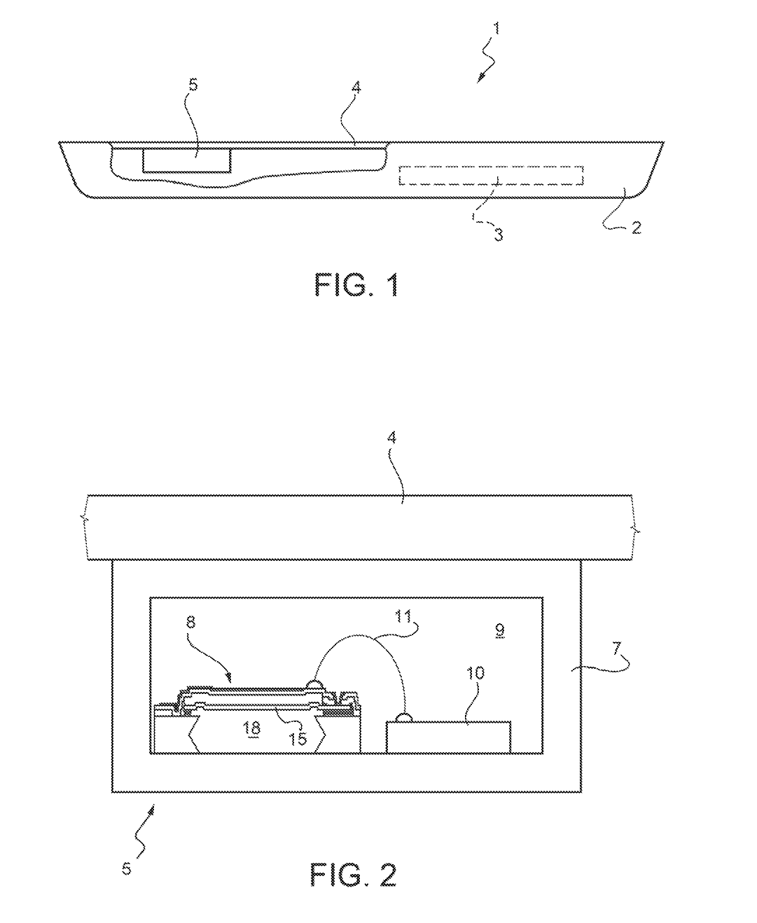

In FIG. 1, a portable communication/processing device is designated by the reference number 1. In the embodiment of FIG. 1, the device 1 is a smartphone. Purely by way of example, the device 1 could alternatively be a tablet, a portable computer, a wearable device, such as a smart watch, or a filming device such as a video camera or a photographic camera.

The device 1 comprises a package 2, housed in which is a processing unit 3, and is provided with a touch-screen 4 arranged for closing the package 2. Further, a vibration sensor 5 is fixed to the touch-screen 4 and is coupled in communication with the processing unit 3. In one embodiment, one face of the vibration sensor 5 is directly joined to an internal face of the touch-screen 4, for example by an adhesive layer, here not illustrated. In this way, the touch-screen 4 and the vibration sensor 5 are rigidly connected together. Consequently, vibrations of the touch-screen 4, for example following upon a touch event, cause corresponding oscillatory movements of the vibration sensor 5.

As shown in FIG. 2, in one embodiment the vibration sensor 5 comprises a package structure 7, housed in which are a membrane microelectromechanical transducer 8 of a capacitive type and a read and control circuit 10, which are provided in distinct chips and are connected together by wire bonding 11.

The package structure 7, for example an integrated-circuit package of a plastic or ceramic type, delimits a cavity 9 and seals it acoustically from the outside world. In particular, the package structure 7 is closed and is made in such a way that the incident acoustic waves are dampened and are not transmitted to the microelectromechanical transducer 8 inside the cavity 9. In one embodiment, a vacuum may be formed in the cavity 9. Alternatively, the cavity 9 may be filled with a gas (for example, air) or with a solid filling material (for example, a resin).

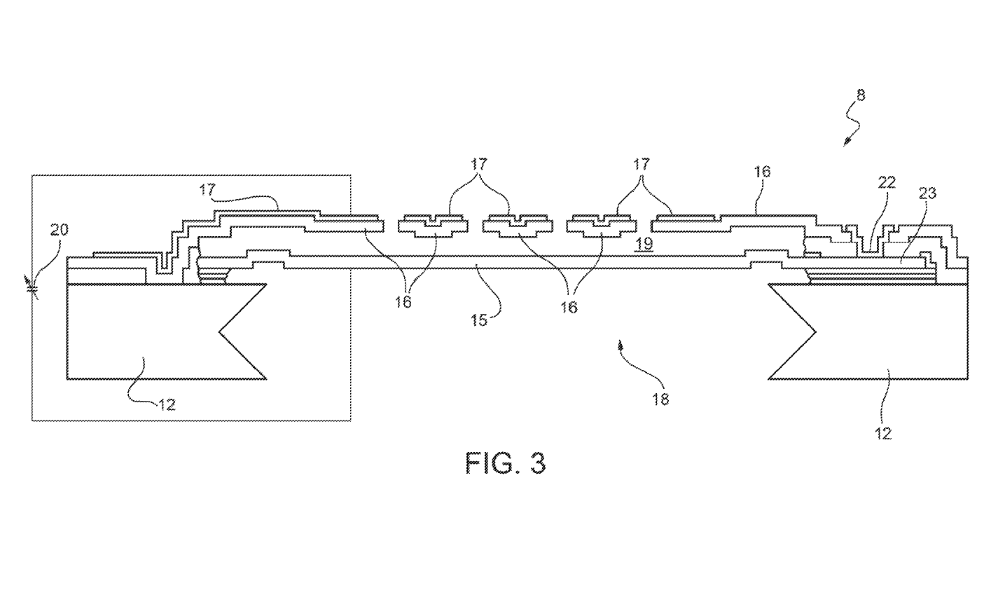

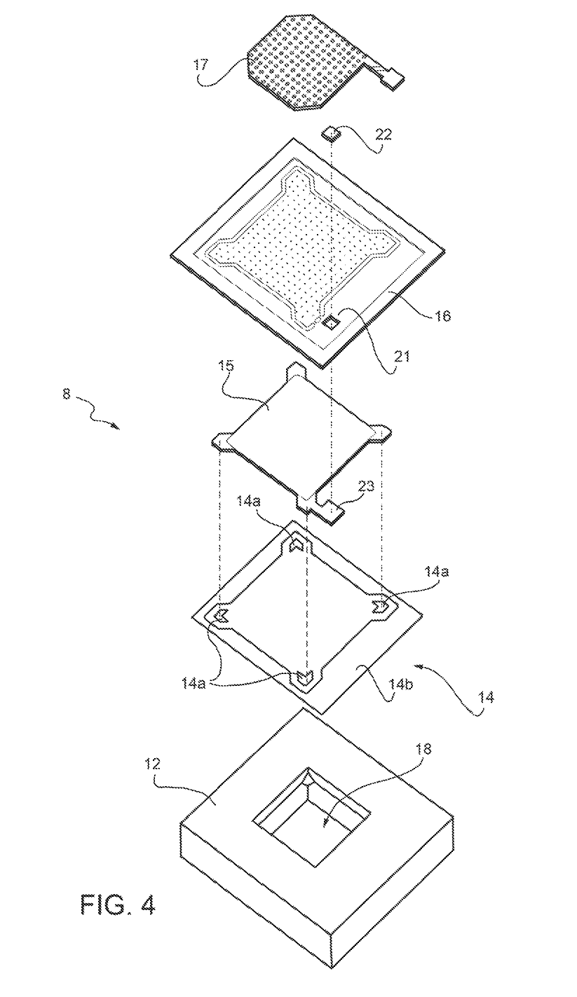

The microelectromechanical transducer 8 is shown in greater detail in FIGS. 3 and 4 and comprises a substrate 12, an anchorage layer 14, a membrane 15 of semiconductor material, a rigid plate 16, and a reference electrode 17.

In the substrate 12 a through cavity is formed, which defines a first chamber 18 delimited on one side by a wall of the package structure 7 (FIG. 2) and on the other by the membrane 15 (FIGS. 3 and 4).

The membrane 15 is fixed to the substrate 12 through anchorages 14a of the anchorage layer 14 and is spread out to cover the first chamber 18. In one embodiment, the membrane 15 has a generally quadrangular shape and has the four vertices fixed to respective anchorages 14a. Further, the membrane 15 is elastically deformable and is doped to be electrically conductive. The mechanical properties of the membrane 15 are basically determined by the type of material (for example, epitaxial silicon), by the mass, and by the relation between the size and the thickness of the membrane 15 itself. The mechanical properties in turn determine the frequency response of the microelectromechanical transducer 8 and thus the detectable bandwidth.

The plate 16, which is made, for example, of silicon carbide or silicon nitride, is substantially undeformable and is fixed to the substrate 12 through an outer frame 14a of the anchorage layer 14. The plate 16 is located on the opposite side of the membrane 15 with respect to the first chamber 18 and delimits, with the membrane 15 itself, a second chamber 19. The second chamber 19 may be in fluid communication with the first chamber 18 and with the cavity 9 (when this is not filled with a solid filling material) or else may be fluidically decoupled from one of the two or from both.

In one embodiment, the plate 16 carries the reference electrode 17 on one face, for example an outer face. In one embodiment, the plate 16 and the reference electrode 17 have openings, thus placing the second chamber 19 in fluid communication with the cavity 9.

The membrane 15 and the reference electrode 17 define the plates of a variable capacitor 20, the capacitance of which is determined by the state of deformation of the membrane 15. Consequently, reading of the capacitance of the variable capacitor 20 provides information on the accelerations perpendicular to the membrane 15 that modify the state of the membrane 15 itself

Through an opening 21 in the plate 16, a membrane electrode 22 contacts a coplanar pad 23 electrically connected to the membrane 15.

The vibration sensor 5 described presents the advantage of using a microelectromechanical transducer that is simple to manufacture and has a wider detection bandwidth as compared to alternative transducers, in particular as compared to conventional microelectromechanical accelerometers. The passband of the capacitive membrane microelectromechanical transducer 8 may in fact extend up to some tens of kilohertz and may be easily controlled during the manufacturing step by acting on the mass and dimensions of the membrane. For example, the capacitive microelectromechanical transducer may make it possible to achieve an output data rate higher than 30 kHz, as against 4-5 kHz that may be reached with the microelectromechanical accelerometers normally used.

The package structure 7 provides acoustic insulation of the membrane 15 and makes it possible to eliminate interferences in detection of the mechanical vibrations. The membrane 15 is in fact extremely sensitive to stresses and responds also to acoustic waves. The insulation afforded by the package structure 7 makes it possible, instead, to eliminate the source of disturbance and to abate the contribution of noise on the signals generated by the microelectromechanical transducer 8, which represent in practice only the oscillations of the membrane 15 due to the accelerations.

In one embodiment, the vibration sensor 5 may comprise a microelectromechanical microphone, the input port of which has been sealed for obtaining acoustic insulation of the membrane from the surrounding environment.

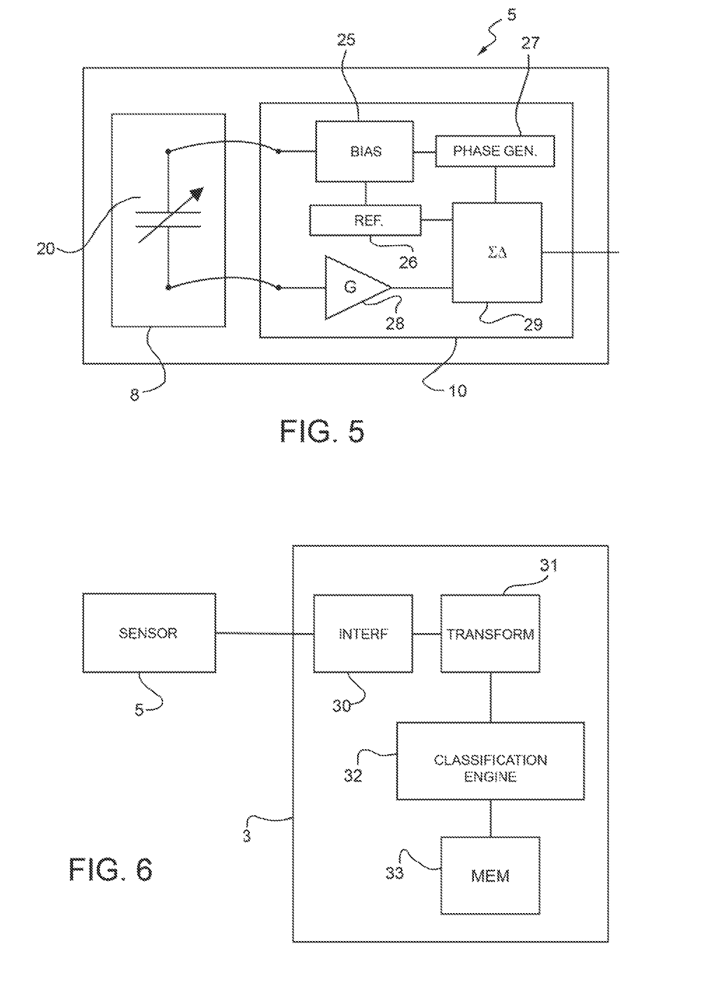

With reference to FIG. 5, the read and control circuit 10 may comprise a bias stage 25, a reference stage 26, a phase-generator stage 27, an amplifier stage 28, and an oversampling converter, for example a sigma-delta converter 29. The phase-generator stage 27 supplies clock signals to the sigma-delta converter 29, which produces a bitstream with high output rate on the basis of transduction signals coming from the microelectromechanical transducer 8 and amplified by the amplifier stage 28.

As shown in FIG. 6, in one embodiment the processing unit 3 comprises an interface module 30, a transform module 31, a classification engine 32, and a memory module 33.

The interface module 30 is coupled to the vibration sensor 5 for receiving transduction signals S_{T}, which are converted into signals in the frequency domain by the transform module 31.

The classification engine 32, by carrying out spectral analysis of the transduction signals S_{T}, recognizes and classifies the touch events using information present in the memory module 33. In one embodiment, the classification engine 32 may be an inferential engine that operates on the basis of a set of rules and templates stored in the memory module 33. For example, the classification engine 32 may discriminate touch events caused by tapping on the touch-screen 4 with a fingertip, a nail, a knuckle, the tip of a stylus, a resilient element (a rubber), etc. The templates may, for example, be in the form of power spectral distributions over significant bands that correspond to typical touch events, or else spectra of sets of parameters that define power spectral distributions (such as frequency, amplitude, and width of power spectral peaks).

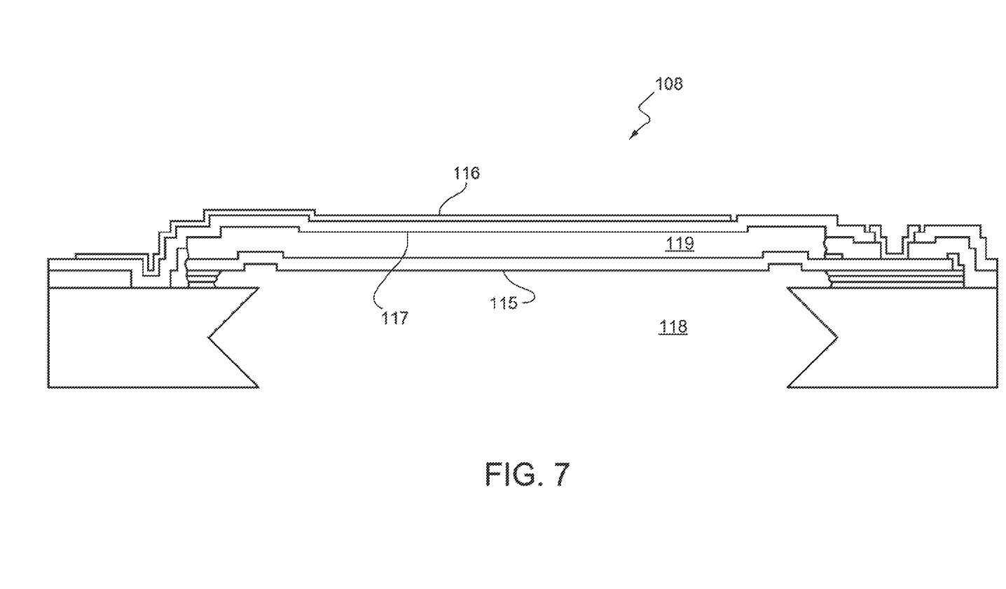

In one embodiment, to which FIG. 7 refers, in a microelectromechanical transducer 108 of a membrane capacitive type, the plate 116 and the reference electrode 117 are continuous and without openings in the portion corresponding to the membrane 115. In this case, the membrane 115 is arranged between a first chamber 118 in a substrate 112 of the microelectromechanical transducer 108 and a second chamber 119 delimited and sealed by the plate 116.

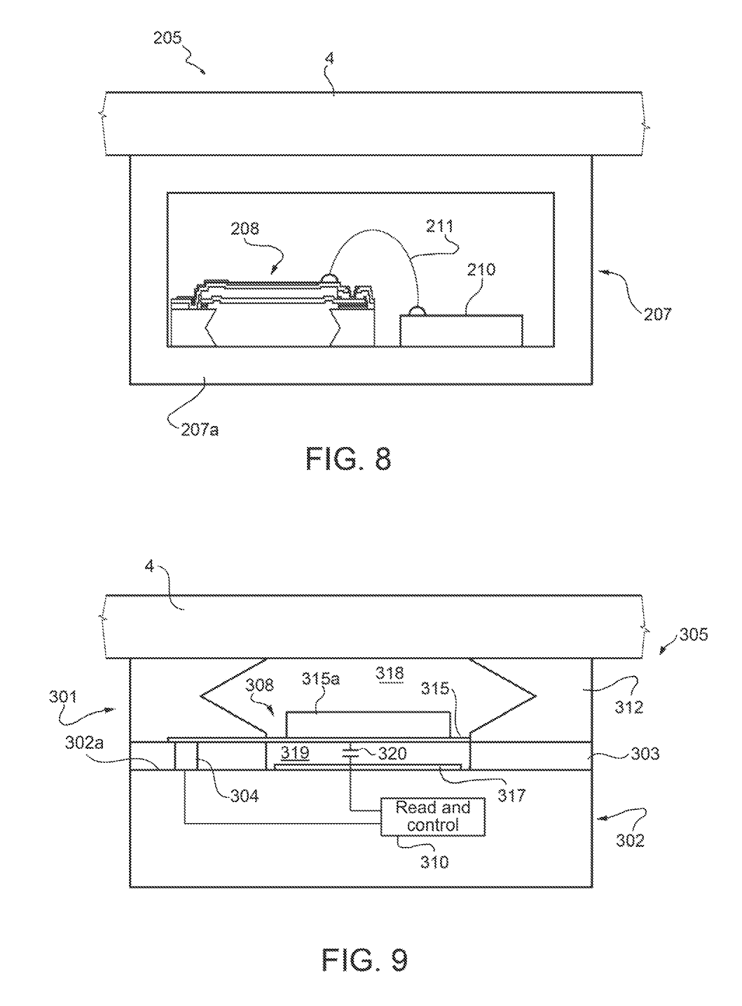

According to a further embodiment of the invention, illustrated in FIG. 8, a vibration sensor 205 comprises a package structure 207, housed in which are a microelectromechanical membrane transducer 208 of a capacitive type and a read and control circuit 210, which are provided in distinct chips and are connected together by wire bonding 211.

The microelectromechanical transducer 208 and the read and control circuit 210 may be substantially of a type already described previously.

The package structure 207 in this case comprises a shell 207a that contains the microelectromechanical transducer 208 and the read and control circuit 210, and is open on a side coupled to a closing body, for example an internal face of the touch-screen 4. In this case, the closing body, i.e., the touch-screen 4, is an integral part of the package structure 207.

A further embodiment of the invention is illustrated in FIG. 9. In this case, a vibration sensor 305 comprises a die, which is formed by a chip 301 and a chip 302 and incorporates a microelectromechanical transducer 308 and a read and control circuit 310.

The microelectromechanical transducer 308 comprises a semiconductor membrane 315 integrated in the chip 301 and a reference electrode 317.

The membrane 315 is spread out to cover one side of a first chamber 318, defined by a through cavity in a substrate 312 of the chip 301. Furthermore, the membrane 315 is elastically deformable and is doped to be electrically conductive. An auxiliary mass 315a is fixed to the membrane 315 in order to increase the sensitivity of the microelectromechanical transducer 308. The auxiliary mass 315a may extend in the first chamber 318, in a second chamber 319, or partially in both. On the opposite side of the chamber 318 with respect to the membrane 315, the chamber 318 is delimited by an internal face of the touch-screen 4, to which the chip 301 is joined. Fixing of the chip 301 to the touch-screen 4 is obtained for insulating the chamber 318 acoustically from the external environment.

The reference electrode 317, which is substantially planar and rigid, is arranged on a face 302a of the chip 302 oriented in the direction of the chip 301 and is capacitively coupled to the membrane 315 for forming a variable capacitor 320. The face 302a of the chip 302 also functions as supporting plate for the reference electrode 317. More precisely, in one embodiment, the face 302a of the chip 302 is joined to the chip 301 by an adhesion layer 303 that has an opening in a region corresponding to the membrane 315 and to the reference electrode 317. The membrane 315 and the reference electrode 317 are separated by a gap, which defines the second chamber 319 having a thickness substantially equal to the thickness of the adhesion layer 303. Furthermore, the chip 302 and the adhesion layer 303 complete acoustic insulation of the membrane 315 from the surrounding environment. In practice, the substrate 312 of the chip 301, a portion of the touch-screen 4, the chip 302, and the adhesion layer 303 define a package structure in which the membrane 315 is sealed and acoustically insulated from the outside world.

In one embodiment, the read and control circuit 310 is integrated in the chip 302 and is coupled to the membrane 315 by a connection 304 through the adhesion layer 303 and is coupled to the capacitor 320.

Finally, it is evident that modifications and variations may be made to the microelectromechanical vibration sensor described, without thereby departing from the scope of the present invention.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A microelectromechanical vibration sensor comprising:
a first chamber;
a second chamber;
a semiconductor membrane between the first chamber and the second chamber;
a reference electrode capacitively coupled to the membrane; and
a package structure that encapsulates and acoustically isolates the first chamber, the second chamber and the membrane from environments outside of the package structure.

2. The sensor according to claim 1, comprising a substrate having a cavity that defines the first chamber.

3. The sensor according to claim 2, wherein the membrane is anchored to the substrate and is arranged to cover one side of the first chamber.

4. The sensor according to claim 3, wherein the first chamber is delimited by the package structure on a side opposite to the membrane.

5. The sensor according to claim 2, comprising a supporting structure joined to the substrate and supporting the reference electrode.

6. The sensor according to claim 5, wherein the supporting structure delimits at least in part the second chamber.

7. The sensor according to claim 5, wherein the supporting structure comprises a rigid dielectric plate.

8. The sensor according to claim 5, wherein the supporting structure comprises a semiconductor body.

9. The sensor according to claim 1, wherein the package structure comprises an integrated circuit package.

10. The sensor according to claim 1, comprising an auxiliary mass coupled to the membrane.

11. An electronic device comprising:
a microelectromechanical vibration sensor including:
a first chamber;
a second chamber;
a semiconductor membrane between the first chamber and the second chamber;
a reference electrode capacitively coupled to the membrane and ; and
a package structure that encapsulates and acoustically isolates the first chamber, the second chamber and the membrane from environments external to the package structure; and
a touch-screen, the microelectromechanical vibration sensor being rigidly coupled to the touch-screen, wherein the microelectromechanical vibration sensor is configured to detect vibrations of the touch-screen.

12. The device according to claim 11, comprising a processing unit coupled to the microelectromechanical sensor.

13. The device according to claim 12, wherein the processing unit comprises a memory module, containing templates of typical touch-events, and a classification engine, configured to classify touch-events detected by the microelectromechanical vibration sensor based on the templates stored in the memory module.

14. The device according to claim 11, wherein the package structure comprises a portion of the touch-screen.

15. The device according to claim 11, wherein the device is at least one of a tablet, a portable computer, a wearable device, and a filming device.

16. A method comprising:
forming a microelectromechanical vibration sensor that includes a first chamber and a second chamber, a semiconductor membrane between the first and second chambers, and a reference electrode that is capacitively coupled to the membrane; and
rigidly coupling a touch-screen to the microelectromechanical vibration sensor, wherein the microelectromechanical vibration sensor is configured to detect vibrations of the touch-screen,
wherein the microelectromechanical vibration sensor includes a package structure that encapsulates and acoustically isolates the first and second chambers and the membrane from the environment external to the package structure.

17. The method according to claim 16, wherein rigidly coupling the touch-screen to the microelectromechanical vibration sensor forms part of the package structure that encapsulates and acoustically isolates the first and second chambers and the membrane from the environment external to the package structure.

18. The method according to claim 16, wherein forming the microelectromechanical vibration sensor includes forming package structure, and forming the package structure occurs before rigidly coupling the touch-screen to the microelectromechanical vibration sensor.

19. The method according to claim 16, wherein forming the microelectromechanical vibration sensor includes coupling an integrated circuit to the reference electrode and the membrane.

20. The method according to claim 16, wherein forming the microelectromechanical vibration sensor includes coupling an auxiliary mass to the membrane.
